(19) United States
(12) Patent Application Publication
(10) Pub. No.: US 2024/0018953 A1
(43) Pub. Date: Jan. 18, 2024

(54) SIGHT GLASS ASSEMBLY FOR COLLISION REPAIR PUMP

(71) Applicant: KKU/ISS, Inc., Travelers Rest, SC (US)

(72) Inventor: Robert Fox, Travelers Rest, SC (US)

(73) Assignee: KKU/ISS, Inc., Travelers Rest, SC (US)

(21) Appl. No.: 17/866,153

(22) Filed: Jul. 15, 2022

(51) Int. Cl. F04B 39/12; B60S 5/00

(52) U.S. Cl. CPC F04B 39/12; B60S 5/00

(57) ABSTRACT

A sight glass assembly for ascertaining a hydraulic fluid level in a collision repair pump includes a sight glass disposed between a support plate and a bezel connected to a pump reservoir in which a cavity, in communication with hydraulic fluid from the pump reservoir, is formed between the sight glass and the support plate whereby the hydraulic fluid level is viewable in the sight glass.

### BACKGROUND OF THE DISCLOSURE

Collision repair pump assemblies or ram kits are used, for instance, to provide hydraulic pressure for tools or rams to adjust damaged metal frames, bent fenders or sheet metal panels, and the like. A conventional pump assembly typically includes a pump manifold with a hydraulic fluid-filled reservoir having one-half (½), four, ten, or twenty-ton ram operating capacities that may use a manually operable hand pump or an air/hydraulic foot pump to transfer hydraulic fluid through a supply hose connected to the ram.

Before operating a collision repair pump assembly, a hydraulic fluid level should be checked in its reservoir. However, determining whether there is an acceptable level of hydraulic fluid is difficult to ascertain without opening the reservoir, which, at the very least, delays operation. Still further, an operator may not remember to check the hydraulic fluid level, and the pump would not function properly with insufficient hydraulic fluid in its reservoir.

What is needed in the industry is a hands-free display that indicates a hydraulic fluid level in a pump reservoir before operating a collision repair pump.

### BRIEF SUMMARY OF THE DISCLOSURE

The present disclosure is directed in general to a sight glass assembly for a collision repair pump, which includes a sight glass that displays a hydraulic fluid level in a reservoir before power is applied to the pump.

In one embodiment according to the disclosure, a pump assembly includes a reservoir tube secured to a pump manifold at one end of the tube with a bolt extending through the reservoir tube and projecting from an opposite end of the tube to receive a sight glass assembly through which the bolt extends. The sight glass assembly is in fluid communication with the reservoir tube such that a sight glass of the sight glass assembly displays a hydraulic fluid level in the reservoir tube and readily alerts an operator if fluid is needed before operating the pump assembly.

In another embodiment, a sight glass system for a hydraulic pump may include a hydraulic reservoir configured to hold hydraulic fluid and having a rod extending therethrough, the rod having a proximal end and a distal end, the proximal end configured for connection to or in a manifold, the distal end having a threaded connector arranged thereon; and a sight glass assembly further including a support plate having a first aperture disposed therethrough, a shoulder disposed in the support plate projecting in a direction away from the hydraulic reservoir, a cavity formed about the shoulder for holding a portion of the hydraulic fluid from the hydraulic reservoir, a fluid aperture spaced apart from the first aperture, the fluid aperture being in fluid communication with the hydraulic reservoir and the cavity, the distal end of the rod extending through the first aperture; a sight glass having a second aperture disposed therethrough, the distal end of the extending through the second aperture, the sight glass being configured to view a level of the hydraulic fluid in the cavity; a bezel having a third aperture disposed therethrough, the distal end of the rod extending through the third aperture, the bezel and the support plate being configured for connection to capture the sight glass therebetween; and a threaded cap being configured for attachment to the threaded connector of the rod.

Also in this embodiment, the support plate of the sight glass system may include threads and the bezel may include complementary threads such that the threads and the complementary threads can engage each other to connect the support plate and the bezel.

Still further, the sight glass in this embodiment may be pressed against the shoulder to form the cavity, and an O-ring may be located between the connector and the shoulder to form a seal. An O-ring also may be inserted between the bezel and the sight glass to form a seal, and a further O-ring inserted between the support plate and the hydraulic reservoir to form a seal therebetween.

In another embodiment, a sight glass system for a hydraulic pump may include a rod having a distal end and a proximal end, the proximal end being configured for insertion in a pump manifold, the distal end having a connector, which may be a threaded end, arranged thereon depending from a hydraulic reservoir configured to hold hydraulic fluid; and a sight glass assembly including a support plate having a first aperture formed therethrough, a shoulder disposed in the support plate projecting in a direction away from the hydraulic reservoir, a cavity formed about the shoulder for holding a portion of the hydraulic fluid from the hydraulic reservoir with the sight glass pressed against the shoulder to form the cavity, a fluid aperture spaced apart from the first aperture, the fluid aperture in fluid communication with the hydraulic reservoir and the cavity, the distal end of the rod extending through the first aperture; a sight glass having a second aperture formed therethrough, the distal end of the rod extending through the second aperture, the sight glass being configured to view a level of the hydraulic fluid in the cavity; a bezel having a third aperture formed therethrough, the distal end of the extending through the third aperture, the bezel and the support plate being configured for connection to capture the sight glass therebetween; and a cap configured for attachment to the connector of the distal end of the rod.

Also in this embodiment, the support plate may include a plurality of threads and the bezel may have a plurality of complementary threads, the threads and the complementary threads being configured for engagement to connect the support plate and the bezel.

Further in this embodiment, the connector may include connector threads and the cap includes a plurality of complementary cap threads, the connector threads and the cap threads being configured for engagement to connect the cap to the connector. Additionally, O-rings may be provided for creating seals between the connector and the shoulder, the bezel and the sight glass, the support plate and the hydraulic reservoir, and the like.

In yet another embodiment, a sight glass system for a hydraulic pump may include a support plate having a first aperture formed therethrough for passage of a connecting rod having a distal end and a proximal end, a shoulder disposed in the support plate projecting in a direction away from a hydraulic reservoir, a cavity formed about the shoulder for holding a portion of hydraulic fluid from the hydraulic reservoir in which the sight glass may be pressed against the shoulder to form the cavity, a fluid aperture spaced apart from the first aperture, the fluid aperture in fluid communication with the hydraulic reservoir and the cavity, the distal end of the connecting rod extending through the first aperture; a sight glass having a second aperture formed therethrough for passage of the connecting rod, the distal end of the connecting rod extending from the second aperture, the sight glass being configured to view a level of the hydraulic fluid in the cavity; and a bezel having a third aperture formed therethrough for passage of the connecting rod, the distal end of the connecting rod extending from the third aperture, the bezel and the support plate being configured for connection to capture the sight glass therebetween.

The support plate in this embodiment may include threads and the bezel may include complementary threads such that the threads and the complementary threads engage each other to connect the support plate and the bezel.

This embodiment may further include the hydraulic reservoir with a portion of the bezel being connectable thereto, and a cap configured for attachment to the distal end of the connecting rod upon passage of the connecting rod through the first, second, and third apertures.

Additional objects and advantages of the present subject matter are set forth in, or will be apparent to, those of ordinary skill in the art from the description herein. Also, it should be further appreciated that modifications and variations to the specifically illustrated, referenced, and discussed features, processes, and elements hereof may be practiced in various embodiments and uses of the disclosure without departing from the spirit and scope of the subject matter. Variations may include, but are not limited to, substitution of equivalent means, features, or steps for those illustrated, referenced, or discussed, and the functional, operational, or positional reversal of various parts, features, steps, or the like. Those of ordinary skill in the art will better appreciate the features and aspects of the various embodiments, and others, upon review of the remainder of the specification.

### BRIEF DESCRIPTION OF THE DRAWINGS

A full and enabling disclosure of the present subject matter, including the best mode thereof directed to one of ordinary skill in the art, is set forth in the specification, which refers to the appended figures, wherein:

FIG. 1 is an exploded, perspective view of an embodiment of the disclosure particularly showing a sight glass assembly for a collision repair pump including a reservoir connectable to a manifold portion (partially shown);

FIG. 2 is an assembled, front elevational view of the embodiment as in FIG. 1 particularly showing a fluid level in the sight glass assembly;

FIG. 3 is a rear elevational view taken along lines in FIG. 1; and

FIG. 4 is an assembled, partially cutaway sight glass assembly as in FIGS. 1 and 2.

### DETAILED DESCRIPTION OF THE DISCLOSURE

As required, detailed embodiments are disclosed herein; however, the disclosed embodiments are merely exemplary and may be embodied in various forms. Therefore, specific structural and functional details disclosed herein are not to be interpreted as limiting, but as bases for the claims and as a representative basis for teaching one skilled in the art to variously employ the exemplary embodiments of the present disclosure, as well as their equivalents.

Unless defined otherwise, all technical and scientific terms used herein have the same meaning as is commonly understood by one of ordinary skill in the art to which this disclosure belongs. In the event that there is a plurality of definitions for a term or acronym herein, those in this section prevail unless stated otherwise.

Wherever the phrases “for example,” “such as,” “including,” and the like are used herein, the phrase “and without limitation” is understood to follow unless explicitly stated otherwise. Similarly, “an example,” “exemplary,” and the like are understood to be non-limiting.

The term “substantially” allows for deviations from the descriptor that do not negatively impact the intended purpose. Descriptive terms are understood to be modified by the term “substantially” even if the word “substantially” is not explicitly recited.

The term “about” when used in connection with a numerical value refers to the actual given value, and to the approximation to such given value that would reasonably be inferred by one of ordinary skill in the art, including approximations due to the experimental and or measurement conditions for such given value.

Unless the context clearly requires otherwise, throughout the description and the claims, the words “comprise,” “comprising,” and the like are to be construed in an inclusive sense as opposed to an exclusive or exhaustive sense; in the sense of “including, but not limited to.”

The terms “comprising” and “including” and “having” and “involving” (and similarly “comprises,” “includes,” “has,” and “involves”) and the like are used interchangeably and have the same meaning. Specifically, each of the terms is defined consistent with the common United States patent law definition of “comprising” and is therefore interpreted to be an open term meaning “at least the following,” and is also interpreted not to exclude additional features, limitations, aspects, et cetera. Thus, for example, “a device having components a, b, and c” means that the device includes at least components a, b, and c. Similarly, the phrase: “a method involving a, b, and c” means that the method includes at least steps a, b, and c.

Where a list of alternative component terms is used, e.g., “a structure such as ‘a,’ ‘b,’ ‘c,’ ‘d,’ or the like,” or “a” or b,” such lists and alternative terms provide meaning and context for the sake of illustration, unless indicated otherwise. Also, relative terms such as “first,” “second,” “third,” “left,” “right,” “front,” “rear,” et cetera are intended to identify or distinguish one component or feature from another similar component or feature, unless indicated otherwise herein.

When a list of element names are provided with a component or step element number, the names are understood as identifying, nonlimiting, alternative nomenclature for that component or step; e.g., “bird, poultry, or fowl 10” means element number 10 may mean and be referred to by any of the listed nomenclature.

The various embodiments of the disclosure and/or equivalents falling within the scope of the present disclosure overcome or ameliorate at least one of the disadvantages of the prior art.

Detailed reference will now be made to the drawings in which examples embodying the present subject matter are shown. The detailed description uses numerical and letter designations to refer to features of the drawings. The drawings and detailed description provide a full and written description of the present subject matter, and of the manner and process of making and using various exemplary embodiments, so as to enable one skilled in the pertinent art to make and use them, as well as the best mode of carrying out the exemplary embodiments. The drawings are not necessarily to scale, and some features may be exaggerated to show details of particular components. Thus, the examples set forth in the drawings and detailed descriptions are provided by way of explanation only and are not meant as limitations of the disclosure. The present subject matter thus includes any modifications and variations of the following examples as come within the scope of the appended claims and their equivalents.

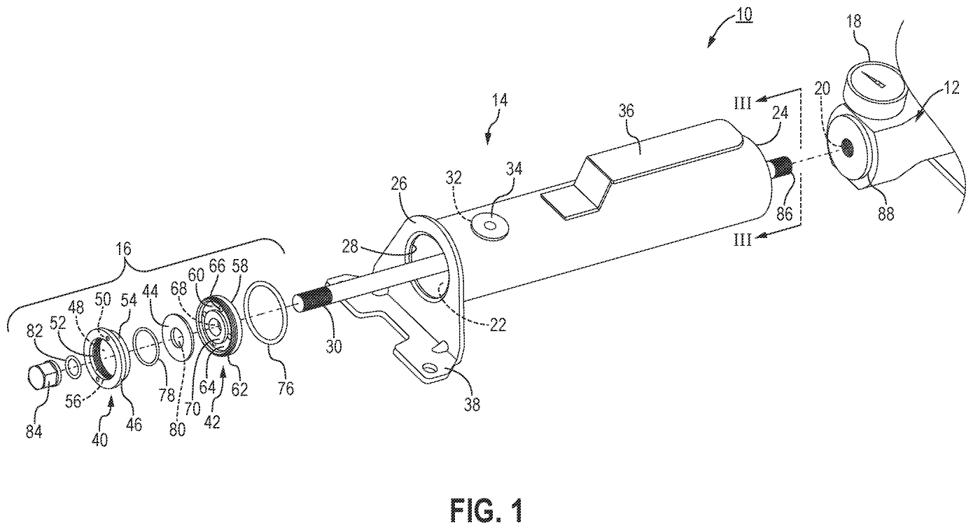

Turning now to FIG. 1, an exemplary collision repair pump assembly is designated broadly by the element number 10. The pump assembly 10 may include a pump manifold 12 (partially shown to provide intended use context), a reservoir assembly or tube 14, and a sight glass assembly 16. As shown, the pump manifold 12 may include a pressure gauge 18, a bolt receiver or receptacle 20, and a receiver projection or shoulder 88, as discussed in further detail below. Here, the pressure gauge 18 will indicate a force, e.g., in gradations of tons, generated at the end of a ram (not shown) connected to the pump manifold 12. Although a needle-type gauge 18 is shown by way of example, a digital or other type of pressure gauge may be utilized.

The reservoir assembly 14 in FIG. 1 may include a hydraulic fluid reservoir 22 situated between a first end 24 and a second end 26 of the reservoir assembly 14. In this example, the first end 24 and a projecting bolt end 86 are constructed for mating with the bolt receiver 20 and the shoulder 88, while the second end 26 has a receptacle or opening 28 for receiving a bezel 40 with a threaded rod or bolt 30 extending from the opening 28, as described below. Also in this example, the reservoir assembly 14 may be cylindrically shaped and may include a fluid filling port 32 having a plug or cap 34. The reservoir assembly 14 may further include a carrying handle 36 and a base, mount, stand, or feet 38, which, if required, can be anchored to ground, a table, a platform, or the like by bolts or other fasteners (not shown).

FIG. 1 further shows that the sight glass assembly 16 includes the bezel 40 briefly introduced above, as well as a backup or support plate 42, and a sight glass 44. As shown, the exemplary bezel 40 includes a rim or perimeter 46 with a bezel aperture 48 and may also include openings or holes 50 for a tool such as an expansion wrench (not shown) to render the bezel 40 stationary during assemblage of the sight glass assembly 16. The bezel 40 may further include a receptacle 52 located within a shoulder portion 54 projecting from the rim 46 for receiving the backup plate 42, as well as an O-ring pocket 56, which are discussed in detail below. The shoulder portion 54 may be threaded for threading into the second end 26, or alternatively the second end 26 and the shoulder portion 54 may be press-fit or anchored together with screws (not shown). More particularly, the opening 28 of the second end 26, by way of example, may be formed with female threads, and the shoulder portion 54 may have male threads to attach to the female threads of the opening 28, although the respective thread arrangements may be reversed.

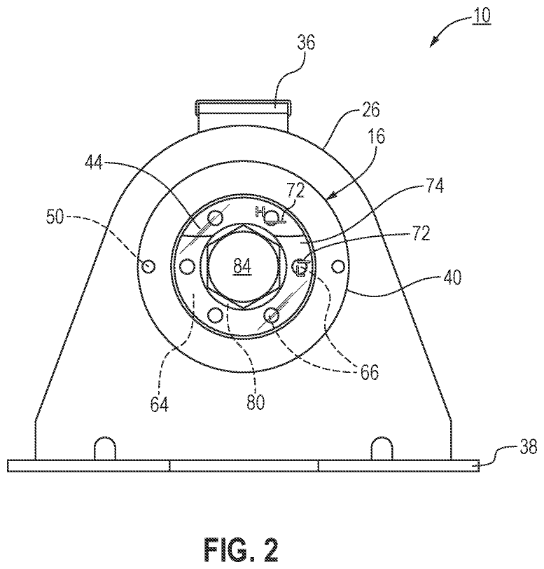

The exemplary backup plate 42 in FIG. 1 includes a first reservoir side 58, a second sight glass side 60, and a threaded perimeter 62. Briefly, after assembly with the bezel 40, the reservoir side 58 of the backup plate 42 is inserted into the opening 28 of the second end 26 with the second sight glass side 60 facing away from the hydraulic fluid reservoir 22. More particularly, the sight glass side 60 includes a raceway or cavity 64, at least one fluid aperture 66, and a plate aperture or through-hole 68 formed through a circular-shaped barrier, projection, or shoulder 70. Thus, when the perimeter 62 of the plate 42 is threaded with the receptacle 52 of the bezel 40 and the reservoir side 58 is inserted into the opening 28 by threading the shoulder portion 54 into the opening 28, and the assembly is complete, the fluid reservoir 22 can be filled with hydraulic fluid 74 (see FIG. 2) via the fluid filling port 32. The hydraulic fluid 74 can then enter the cavity 64 via the aperture(s) 66 for viewing through the sight glass 44. Those skilled in the art will appreciate that relative circumferences and thread arrangements may be reversed such that the receptacle 52 of the bezel 40 could be threaded into the perimeter 62 of the plate 42. Moreover, rather threaded arrangements, or in addition thereto, the bezel 40 and the plate 42 could be press-fitted or snap-fitted together using, e.g., living-spring latches or the like.

FIG. 1 further shows a first, relatively large, elastomeric O-ring 76 that fits between the sight glass assembly 16 and the opening 28 of the second end 26 of the reservoir assembly 14. As briefly introduced above, another (or second) elastomeric O-ring 78 fits into the central O-ring pocket 56 of the bezel 40 to create a seal between the bezel 40 and the sight glass 44. Also as shown in this example, the sight glass 44 is round in shape with a through-hole or glass aperture 80 formed therein through which the threaded bolt 30 projects to receive a reservoir end cap or nut 84. Accordingly, FIG. 1 further shows a third, relatively smaller, elastomeric O-ring 82 that is placed or inserted between the distal end of the threaded rod 30 and the reservoir end cap 84. To further ensure against leaks or component loosening caused by operational vibrations, an optional thread-locking sealer (not shown) may be used between threads of the shoulder portion 54 and the opening 28 of the second end 26, the threads of the receptacle 52 and the perimeter 62, and/or between the rod 30 and the end cap 84.

With reference now to FIG. 2, the assembled sight glass assembly 16 is shown most clearly viewed from the second end 26 of the pump assembly 10. As introduced above, the sight glass assembly 16 is positioned between the handle 36 and the feet 38 of the pump assembly 10. Here, the bezel 40 is attached to the second end 26 using a threaded action as described in detail above. As shown, the sight glass 44 has been pressed into the bezel 40 with its opening 80 surrounding the threaded rod 30 (see FIG. 1), which is capped by the nut 84, which when tightened, seals the components together.

Also shown in FIG. 2, the apertures 66 are in fluid communication with the reservoir 22 such that a portion of the hydraulic fluid 74 in the fluid reservoir 22 enters the cavity 64 and can be viewed through the sight glass 44. As further shown, the sight glass 44 may be a hardened, clear or see-through plastic such as an acrylic or polycarbonate material. By way of example and without limitation, the sight glass material can be Tuffak®, Makrolon®, Lexan®, and other brands. Still further, the sight glass 44 may include etched or stamped fluid level markers 72 such as H (“high”) and L (“low”). However, other markers or labels such as “F” for full and “M” for minimum, or percentages or the like, could be used to indicate the hydraulic fluid level 72. Likewise, those skilled in the art will appreciate that the sight glass assembly 16 and the sight glass 44 are not limited to the circular shapes shown nor to installation at the second end 26 of the reservoir assembly 14. In any event, based on its conspicuous nature and position, the sight glass 44 and its fluid level markers 72 will readily catch the attention of a user before power is applied to the pump assembly 10. Accordingly, if the sight glass 44 indicates that the hydraulic fluid 74 is at a deficient “L” level 72, hydraulic fluid 74 can be added to the fluid reservoir 22 via the fluid filling port 32 (see FIG. 1), thereby preventing malfunction of the pump assembly 10.

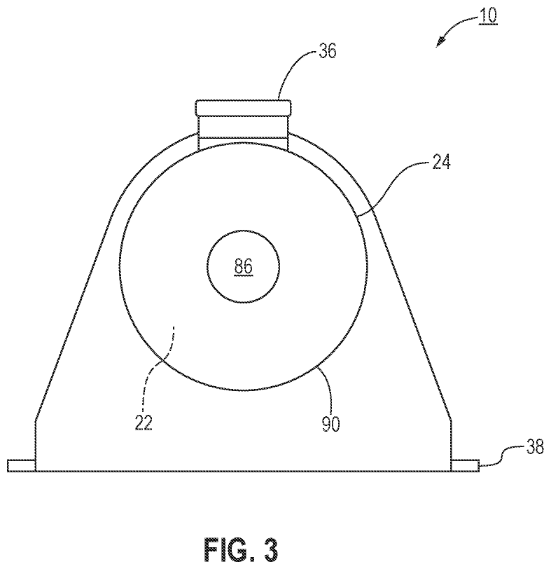

Turning to FIG. 3, a portion of the pump assembly 10 is seen from the first end 24 showing the handle 36 above the feet 38. Here, the manifold end 86 of the bolt 30 is surrounded by a recess or channel 90 formed in the first end 24, as introduced above with respect to FIG. 1. The channel 90 is for receiving the receiver shoulder 88 of the pump manifold 12 when the pump assembly 10 is assembled. More particularly, as shown here, the manifold end 86 is arranged to project into and connect to the reservoir receiver 20. In this example, the manifold end 86 of the bolt 30 has male threads and the receiver 20 has female threads (see FIG. 1), but other arrangements and connection mechanisms could be used in the alternative, or in addition to the exemplary threaded arrangement.

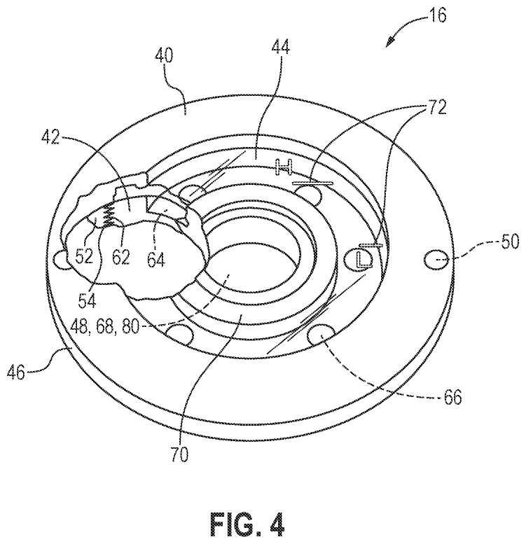

FIG. 4 shows the assembled sight glass assembly 16 partially cutaway to further illustrate an interrelationship of components. As described above and shown here, the receptacle 52 of the bezel 40 has been threaded with the perimeter 62 of the plate 42 with the sight glass 44 therebetween to form the sight glass assembly 16. Here also, the shoulder portion 54 of the bezel 40 extends from the sight glass assembly 16 for threading, snapping, or press-fitting into opening 28 of the second end 26, as discussed above.

FIG. 4 also shows the sight glass 44 pressed against the shoulder 70 to assist in forming the cavity 64, which holds the hydraulic fluid 74 (see FIG. 2) that has entered through the apertures 66, as described in detail above. The fluid 74 can then be viewed through the sight glass 44 and its level readily ascertained relative to the sight glass markers 72. Also shown in this assembled state, the bezel (or third) aperture 48, the plate (or first) aperture 68, and the glass (or second) aperture 80 are concentrically aligned for the rod 30 to extend therethrough (see FIG. 1).

Exemplary embodiments as disclosed herein may include but are not limited to:

### Embodiment 1

A sight glass system for a hydraulic pump comprising a hydraulic reservoir configured to hold hydraulic fluid and having a rod extending therethrough, the rod having a proximal end and a distal end, the proximal end configured for connection to or in a manifold, the distal end having a threaded connector arranged thereon; and a sight glass assembly, further comprising a support plate having a first aperture disposed therethrough, a shoulder disposed in the support plate projecting in a direction away from the hydraulic reservoir, a cavity formed about the shoulder for holding a portion of the hydraulic fluid from the hydraulic reservoir, a fluid aperture spaced apart from the first aperture, the fluid aperture being in fluid communication with the hydraulic reservoir and the cavity, the distal end of the rod extending through the first aperture; a sight glass having a second aperture disposed therethrough, the distal end of the extending through the second aperture, the sight glass being configured to view a level of the hydraulic fluid in the cavity; a bezel having a third aperture disposed therethrough, the distal end of the rod extending through the third aperture, the bezel and the support plate being configured for connection to capture the sight glass therebetween; and a threaded cap being configured for attachment to the threaded connector of the rod.

### Embodiment 2

The sight glass system as in embodiment 1, wherein the support plate includes a plurality of threads and the bezel includes a plurality of complementary threads, the threads and the complementary threads being configured for engagement to connect the support plate and the bezel.

### Embodiment 3

The sight glass system as in embodiments 1 or 2, wherein the sight glass is pressed against the shoulder to form the cavity

### Embodiment 4

The sight glass system as in any of the foregoing embodiments, further comprising an O-ring disposed between the connector and the shoulder to form a seal therebetween.

### Embodiment 5

The sight glass system as in any of the foregoing embodiments, further comprising an O-ring disposed between the bezel and the sight glass to form a seal therebetween.

### Embodiment 6

The sight glass system as in any of the foregoing embodiments, further comprising an O-ring disposed between the support plate and the hydraulic reservoir to form a seal therebetween.

### Embodiment 7

A sight glass system for a hydraulic pump comprising a rod having a distal end and a proximal end, the proximal end being configured for insertion in a pump manifold, the distal end having a connector arranged thereon depending from a hydraulic reservoir configured to hold hydraulic fluid; and a sight glass assembly including a support plate having a first aperture formed therethrough, a shoulder disposed in the support plate projecting in a direction away from the hydraulic reservoir, a cavity formed about the shoulder for holding a portion of the hydraulic fluid from the hydraulic reservoir, a fluid aperture spaced apart from the first aperture, the fluid aperture in fluid communication with the hydraulic reservoir and the cavity, the distal end of the rod extending through the first aperture; a sight glass having a second aperture formed therethrough, the distal end of the rod extending through the second aperture, the sight glass being configured to view a level of the hydraulic fluid in the cavity; a bezel having a third aperture formed therethrough, the distal end of the extending through the third aperture, the bezel and the support plate being configured for connection to capture the sight glass therebetween; and a cap being configured for attachment to the connector of the distal end of the rod.

### Embodiment 8

The sight glass system as in embodiment 7, wherein the connector is a plurality of threads.

### Embodiment 9

The sight glass system as in embodiments 7 or 8, wherein the support plate includes a plurality of threads and the bezel includes a plurality of complementary threads, the threads and the complementary threads being configured for engagement to connect the support plate and the bezel.

### Embodiment 10

The sight glass system as in any one of embodiments 7 through 9, wherein the sight glass is pressed against the shoulder to form the cavity.

### Embodiment 11

The sight glass system as in any one of embodiments 7 through 10, wherein the connector includes a plurality of connector threads and the cap includes a plurality of complementary cap threads, the connector threads and the cap threads being configured for engagement to connect the cap to the connector.

### Embodiment 12

The sight glass system as in any one of embodiments 7 through 11, further comprising a plurality of O-rings configured for sealing, the O-rings being disposed between components selected from the group consisting of the connector and the shoulder, the bezel and the sight glass, the support plate and the hydraulic reservoir, and combinations thereof.

### Embodiment 13

A sight glass system for a hydraulic pump, comprising a support plate having a first aperture formed therethrough for passage of a connecting rod having a distal end and a proximal end, a shoulder disposed in the support plate projecting in a direction away from a hydraulic reservoir, a cavity formed about the shoulder for holding a portion of hydraulic fluid from the hydraulic reservoir, a fluid aperture spaced apart from the first aperture, the fluid aperture in fluid communication with the hydraulic reservoir and the cavity, the distal end of the connecting rod extending through the first aperture; a sight glass having a second aperture formed therethrough for passage of the connecting rod, the distal end of the connecting rod extending from the second aperture, the sight glass being configured to view a level of the hydraulic fluid in the cavity; and a bezel having a third aperture formed therethrough for passage of the connecting rod, the distal end of the connecting rod extending from the third aperture, the bezel and the support plate being configured for connection to capture the sight glass therebetween.

### Embodiment 14

The sight glass system as in embodiment 13, wherein the support plate includes a plurality of threads and the bezel includes a plurality of complementary threads, the threads and the complementary threads being configured for engagement to connect the support plate and the bezel.

### Embodiment 15

The sight glass system as in embodiments 13 or 14, wherein the sight glass is pressed against the shoulder to form the cavity.

### Embodiment 16

The sight glass system as in embodiments 13 through 15, further comprising the hydraulic reservoir, a portion of the bezel being connectable thereto.

### Embodiment 17

The sight glass system as in embodiments 13 through 16, further comprising a cap being configured for attachment to the distal end of the connecting rod upon passage of the connecting rod through the first, second, and third apertures.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

1. A sight glass system for a hydraulic pump, comprising:
a hydraulic reservoir configured to hold hydraulic fluid and having a rod extending therethrough, the rod having a proximal end and a distal end, the proximal end configured for connection to a manifold, the distal end having a threaded connector arranged thereon; and
a sight glass assembly, further comprising:
a support plate having a first aperture disposed therethrough, a shoulder disposed in the support plate projecting in a direction away from the hydraulic reservoir, a cavity formed about the shoulder for holding a portion of the hydraulic fluid from the hydraulic reservoir, a fluid aperture spaced apart from the first aperture, the fluid aperture being in fluid communication with the hydraulic reservoir and the cavity, the distal end of the rod extending through the first aperture;
a sight glass having a second aperture disposed therethrough, the distal end of the rod extending through the second aperture, the sight glass being configured to view a level of the hydraulic fluid in the cavity;
a bezel having a third aperture disposed therethrough, the distal end of the rod extending through the third aperture, the bezel and the support plate being configured for connection to capture the sight glass therebetween; and
a threaded cap being configured for attachment to the threaded connector of the rod.

2. The sight glass system as in claim 1, wherein the support plate includes a plurality of threads and the bezel includes a plurality of complementary threads, the threads and the complementary threads being configured for engagement to connect the support plate and the bezel.

3. The sight glass system as in claim 1, wherein the sight glass is pressed against the shoulder to form the cavity.

4. The sight glass system as in claim 1, further comprising an O-ring disposed between the threaded connector and the shoulder to form a seal therebetween.

5. The sight glass system as in claim 1, further comprising an O-ring disposed between the bezel and the sight glass to form a seal therebetween.

6. The sight glass system as in claim 1, further comprising an O-ring disposed between the support plate and the hydraulic reservoir to form a seal therebetween.

7. A sight glass system for a hydraulic pump, comprising:
a rod having a distal end and a proximal end, the proximal end being configured for insertion in a pump manifold, the distal end having a connector arranged thereon depending from a hydraulic reservoir configured to hold hydraulic fluid; and
a sight glass assembly including:
a support plate having a first aperture formed therethrough, a shoulder disposed in the support plate projecting in a direction away from the hydraulic reservoir, a cavity formed about the shoulder for holding a portion of the hydraulic fluid from the hydraulic reservoir, a fluid aperture spaced apart from the first aperture, the fluid aperture in fluid communication with the hydraulic reservoir and the cavity, the distal end of the rod extending through the first aperture;
a sight glass having a second aperture formed therethrough, the distal end of the rod extending through the second aperture, the sight glass being configured to view a level of the hydraulic fluid in the cavity;
a bezel having a third aperture formed therethrough, the distal end of the rod extending through the third aperture, the bezel and the support plate being configured for connection to capture the sight glass therebetween; and
a cap being configured for attachment to the connector of the distal end of the rod.

8. The sight glass system as in claim 7, wherein the connector is a plurality of threads.

9. The sight glass system as in claim 7, wherein the support plate includes a plurality of threads and the bezel includes a plurality of complementary threads, the threads and the complementary threads being configured for engagement to connect the support plate and the bezel.

10. The sight glass system as in claim 7, wherein the sight glass is pressed against the shoulder to form the cavity.

11. The sight glass system as in claim 7, wherein the connector includes a plurality of connector threads and the cap includes a plurality of complementary cap threads, the connector threads and the cap threads being configured for engagement to connect the cap to the connector.

12. The sight glass system as in claim 7, further comprising a plurality of O-rings configured for sealing, the O-rings being disposed between components selected from the group consisting of the connector and the shoulder, the bezel and the sight glass, the support plate and the hydraulic reservoir, and combinations thereof.

13. A sight glass system for a hydraulic pump, comprising:
a support plate having a first aperture formed therethrough for passage of a connecting rod having a distal end and a proximal end, a shoulder disposed in the support plate projecting in a direction away from a hydraulic reservoir, a cavity formed about the shoulder for holding a portion of hydraulic fluid from the hydraulic reservoir, a fluid aperture spaced apart from the first aperture, the fluid aperture in fluid communication with the hydraulic reservoir and the cavity, the distal end of the connecting rod extending through the first aperture;
a sight glass having a second aperture formed therethrough for passage of the connecting rod, the distal end of the connecting rod extending from the second aperture, the sight glass being configured to view a level of the hydraulic fluid in the cavity; and
a bezel having a third aperture formed therethrough for passage of the connecting rod, the distal end of the connecting rod extending from the third aperture, the bezel and the support plate being configured for connection to capture the sight glass therebetween.

14. The sight glass system as in claim 13, wherein the support plate includes a plurality of threads and the bezel includes a plurality of complementary threads, the threads and the complementary threads being configured for engagement to connect the support plate and the bezel.

15. The sight glass system as in claim 13, wherein the sight glass is pressed against the shoulder to form the cavity.

16. The sight glass system as in claim 13, further comprising the hydraulic reservoir, a portion of the bezel being connectable thereto.

17. The sight glass system as in claim 13, further comprising a cap being configured for attachment to the distal end of the connecting rod upon passage of the connecting rod through the first, second, and third apertures.

18. A sight glass system for a hydraulic pump, comprising:
a backup plate having a first aperture formed therethrough for passage of a connecting rod having a distal end and a proximal end, a shoulder disposed in the backup plate projecting in a direction away from a hydraulic reservoir, a cavity formed about the shoulder for holding a portion of hydraulic fluid from the hydraulic reservoir, a fluid aperture spaced apart from the first aperture, the fluid aperture in fluid communication with the hydraulic reservoir and the cavity, the distal end of the connecting rod extending through the first aperture; and
a sight glass having a second aperture formed therethrough for passage of the connecting rod, the distal end of the connecting rod extending from the second aperture, the sight glass being configured to view a level of the hydraulic fluid in the cavity.

19. The sight glass system as in claim 18, further comprising a bezel having a third aperture formed therethrough for passage of the connecting rod, the distal end of the connecting rod extending from the third aperture, the bezel and the backup plate being configured for connection to capture the sight glass therebetween.

20. The sight glass system as in claim 18, further comprising a cap being configured for attachment to the distal end of the connecting rod.
